(19) United States
(12) Patent Application Publication
(10) Pub. No.: US 2026/0025483 A1
(43) Pub. Date: Jan. 22, 2026

(54) MULTI-CAMERA IMAGE DATA PROCESSING

(71) Applicant: Nokia Technologies Oy, Espoo (FI)

(72) Inventors: Utku Günay ACER, Antwerp (BE); Chulhong MIN, Cambridge (GB); Fahim KAWSAR, Cambridge (GB); Si Young JANG, Cambridge (GB)

(21) Appl. No.: 18/875,875

(22) PCT Filed: Jun. 23, 2022
(86) PCT No.: PCT/EP2022/067160

§ 371 Date: Dec. 17, 2024

(51) Int. Cl. H04N 7/18; G06T 7/80; G06V 10/26; G06V 10/94; G06V 20/52; H04N 23/61; H04N 23/695

(52) U.S. Cl. CPC H04N 7/181; G06T 7/80; G06V 10/26; G06V 10/95; G06V 20/52; H04N 23/61; H04N 23/695; G06T 2207/30232

(57) ABSTRACT

There is provided method for a multi-camera system comprising at least a first and a second camera, wherein coverage of the first and the second camera is divided into a set of tiles. The method comprises detecting an object in a first region on the first camera's field of view, FOV, and determining a location of the object in terms of one or more tiles. The method further comprises requesting a mapping information identifying one or more tiles in the second camera's FOV that correspond to the one or more tiles in the first camera's FOV, and receiving a response from a view mapping database that is configured to identify the one or more tiles in the second camera's FOV that correspond to the one or more tiles in the first camera's FOV, where the response further identifies one or more additional tiles contiguous with the identified one or more tiles in the second camera's FOV. The response is shared from the first camera to the second camera such that the second camera is enabled to find the object in the one or more of the tiles identified in the response.

### FIELD

Various example embodiments relate to a multi-camera system and to a method, a device and a computer implementable instructions for processing image data produced by the multi-camera system.

### BACKGROUND

A multi-camera video analytics involves object detection and tracking among multiple cameras. A camera of a multi-camera system detects an object or an event that prompts streaming. For example, if multiple cameras detect the same object, unique objects detected by multiple cameras are to be identified. If the detected object moves or the camera changes its direction, the detected object may be away from the current camera view. Then another camera, that is able to capture the object, should continue streaming. When another camera better captures the object, the feed source may be changed. For cameras having fixed and non-overlapping field of views, FOVs, it is sufficient to know locations of the cameras in order to decide which camera shall pick the stream after the object leaves the current FOV.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus for a multi-camera system comprising at least a first camera and a second camera, wherein coverage of the first camera and coverage of the second camera is divided into a set of tiles, the apparatus comprising:
a module configured to detect an object in first region on the first camera's field of view, FOV,
a module configured to determine a location of the object in terms of one or more tiles of the set of tiles in the first camera's view,
a module configured to request a mapping information identifying one or more tiles of the set of tiles in the second camera's FOV that corresponds to the one or more tiles of the set of tiles in the first camera's FOV;
a module configured to receive a response from a view mapping database that is configured to identify the one or more tiles of the set of the tiles in the second camera's FOV that correspond to the one or more tiles of the set of tiles in the first camera's FOV, where the response further identifies one or more additional tiles contiguous with the identified one or more tiles of the set of tiles in the second camera's FOV;
a module configured to share the response from the first camera to the second camera such that the second camera is enabled to find the object in the one or more of the tiles identified in the response.

According to a second aspect, there is provided a method for a multi-camera system, wherein the multi-camera system comprises at least a first camera and a second camera, wherein coverage of the first camera and coverage of the second camera is divided into a set of tiles, the method comprising:
detecting an object in a first region on the first camera's field of view, FOV;
determining a location of the object in terms of one or more tiles of the set of tiles in the first camera's FOV;
requesting a mapping information identifying one or more tiles of the set of tiles in the second camera's FOV that corresponds to the one or more tiles of the set of tiles in the first camera's FOV;
receiving a response from a view mapping database that is configured to identify the one or more tiles of the set of the tiles in the second camera's FOV that correspond to the one or more tiles of the set of tiles in the first camera's FOV, where the response further identifies one or more additional tiles contiguous with the identified one or more tiles of the set of tiles in the second camera's FOV;
sharing the response from the first camera to the second camera such that the second camera is enabled to find the object in the one or more of the tiles identified in the response.
According to a third aspect, there is provided a computer program for causing performance according to the second aspect.

According to a fourth aspect, there is provided a non-transitory computer readable medium comprising program instructions that, when executed by at least one processor, cause a multi-camera system to at least perform:
to detect an object in a first region on the first camera's field of view, FOV;
to determine a location of the object in terms of one or more tiles of the set of tiles in the first camera's FOV;
to request a mapping information identifying one or more tiles of the set of tiles in the second camera's FOV that corresponds to the one or more tiles of the set of tiles in the first camera's FOV;
to receive a response from a view mapping database that is configured to identify the one or more tiles of the set of the tiles in the second camera's FOV that correspond to the one or more tiles of the set of tiles in the first camera's FOV, where the response further identifies one or more additional tiles contiguous with the identified one or more tiles of the set of tiles in the second camera's FOV;
to share the response from the first camera to the second camera such that the second camera is enabled find the object in one or more of the tiles identified in the response

According to a fifth aspect, there is provided an apparatus for a multi-camera system, wherein the multi-camera system comprises at least a first camera and a second camera, wherein coverage of the first camera and coverage of the second camera is divided into a set of tiles, the apparatus comprising:
means for detecting an object in a first region on the first camera's field of view, FOV;
means for determining a location of the object in terms of one or more tiles of the set of tiles in the first camera's FOV;
means for requesting a mapping information identifying one or more tiles of the set of tiles in the second camera's FOV that corresponds to the one or more tiles of the set of tiles in the first camera's FOV;
means for receiving a response from a view mapping database that is configured to identify the one or more tiles of the set of the tiles in the second camera's FOV that correspond to the one or more tiles of the set of tiles in the first camera's FOV, where the response further identifies one or more additional tiles contiguous with the identified one or more tiles of the set of tiles in the second camera's FOV;
means for sharing the response from the first camera to the second camera such that the second camera is enabled to find the object in the one or more of the tiles identified in the response.

In addition, there is provided a population phase of the view mapping database comprising:
dividing coverage of each camera of the multi-camera system into a set of tiles;
detecting a second object in a second region on a second camera's FOV;
determining a location of the second object in the second camera's FOV in terms of one or more tiles of the set of tiles in the second camera's FOV;
detecting the second object in the first region of the first camera's FOV, the second region of the second camera's FOV at least partially overlapping with the first region of the first camera's FOV;
determining a location of the second object in the first camera's FOV in terms of one or more tiles of the set of tiles in the first camera's FOV;
spatially calibrating the second region in the second camera's FOV to the first region in the first camera's FOV by mapping the one or more tiles determined as the location of the second object in the second camera's FOV to the one or more tiles determined as the location of the second object in the first camera's FOV;
storing the mapping information to a storage location of the view mapping database.

### BRIEF DESCRIPTION OF THE DRAWINGS

In the following the embodiments are described with the accompanying drawings, which are non-limiting, but rather illustrating example implementations.

FIG. 1a shows, by way of example, a flow chart of a method for a multi-camera system;

FIG. 1b shows, by way of example, a flow chart of a method for a population phase of a view mapping database;

FIG. 2 shows, by way of example, a block diagram of an apparatus;

FIG. 3 shows, by way of example, a block diagram of a system;

FIG. 4a-b show, by way of example, an aerial view of two cameras;

FIGS. 4c-d illustrate, by way of example, an aerial view of a camera;

FIG. 5a-d show, by way of example, a region of a camera view;

FIG. 6a-b show, by way of example, mapping a remote camera region to a local camera region; and

FIG. 7a-c show, by way of example, mapping a local camera view.

### DETAILED DESCRIPTION

A view mapping database, VMDB, is presented for mapping regions of camera views in a multi-camera system. For VMDB full coverage of at least some or each camera of the multi-camera system is divided into tiles. The tiles are used as locations of the detected objects. Locations of the common detected objects among camera FOVs are used to populate one or more VMDB instances. Mechanisms for spatial, temporal and/or pan-tilt-zoom (PTZ) calibration are utilized in order to address inaccuracies due to object depth, lack of synchronization and camera movements.

Full or entire coverage of a camera corresponds to a maximum coverage the camera is able to capture. A field of view, FOV, corresponds to a region perceivable by a camera at a particular time instant. For example, an omnidirectional camera has 360 degree coverage, while a FOV may be 120 degrees at a time. Image sensor of a camera is configured to perceive or capture incoming light and to convert incoming light into an electrical signal that can be viewed, analysed or stored. For a stationary camera, or image sensor, full coverage corresponds to the FOV. Adjustable camera configurations and overlapping FOVs may cause challenges to multi-camera object detection and tracking.

In the following “an object” is used, while it may refer to an object or an event. An object may be an object or an event of interest, an object or an event detected in a camera FOV, or an object or an event triggering streaming function.

A region refers to a region of a camera's field of view, for example to detected region, at which an object is detected. A location refers to determined location (of the object). The terms are linked and there is association between the object detection region and the location of the object in the camera FOV. A location of a detected object may be determined by a region comprising one or more tiles.

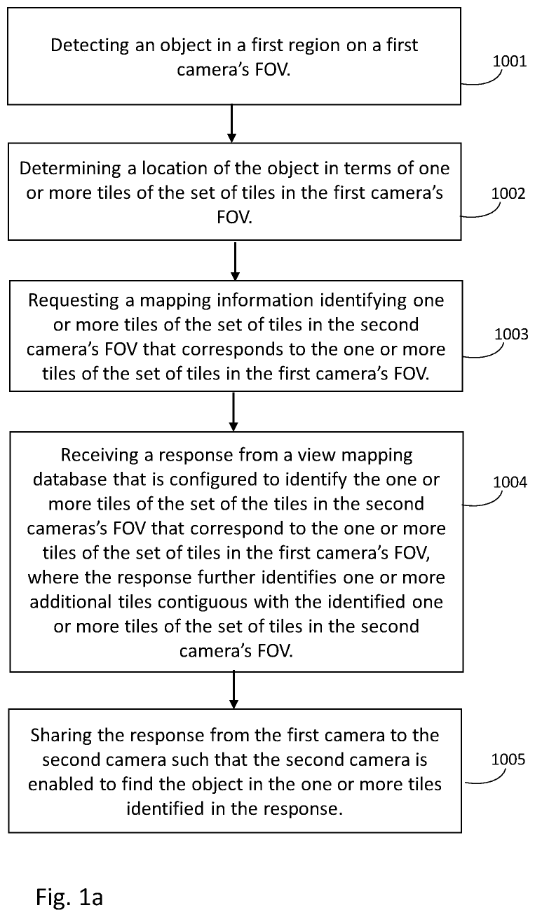

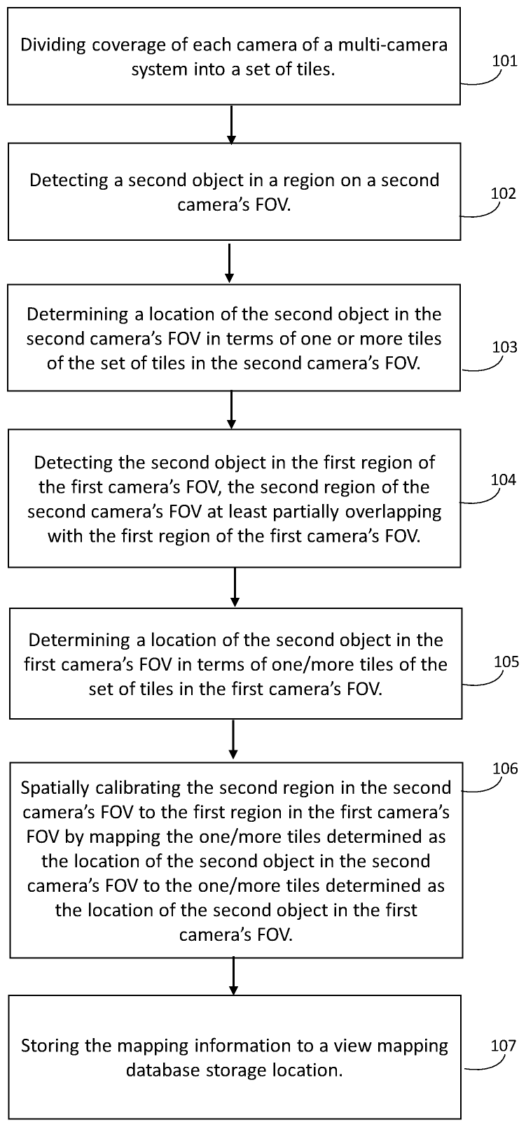

FIG. 1a shows, by way of example, a flowchart of a method for a multi-camera system according to an embodiment. A method utilizes a view mapping database, VMDB, in a multi-camera system. For at least some or all cameras of the system entire coverage of a camera view is divided into tiles. The tiles are used to indicate locations of objects. The method of FIG. 1a comprises detecting an object in a first region on a first camera's FOV 1001, and determining a location of the object in terms of one or more tiles of the set of tiles in the first camera's FOV 1002. The method of FIG. 1a further comprises requesting a mapping information identifying one or more tiles of the set of tiles in the second camera's FOV that correspond to the one or more tiles of the set of tiles in the first camera's FOV 1003. In response to the request, receiving a response from a view mapping database, VMDB, that is configured to identify the one or more tiles of the set of tiles in the second camera's FOV that correspond to the one or more tiles of the set of tiles in the first camera's FOV, where the response further identifies one or more additional tiles contiguous with the identified one or more tiles of the set of tiles in the second camera's FOV 1004. and sharing the response from the first camera to the second camera such that the second camera is enabled to find the object in the one or more tiles identified in the response 1005. The VMDB includes data on locations of the common object among, or in the group of, cameras and/or camera coverages or FOVs of the multi-camera system. Retrieved data comprises tiles of the common object(s) of the one or more other cameras of the multi-camera system. For example, a neighbouring camera, which is best suited as a next source of on ongoing streaming, may be decided based on the retrieved data.

FIG. 1b by way of example, a flowchart of a method for a population phase of a VMDB. The method of FIG. 1b comprises dividing coverage of each camera of the multi-camera system into a set of tiles 101. The tiles are used to indicate locations of objects. The method of FIG. 1b further comprises detecting a second object in a region on a second camera's FOV 102; and determining a location of the second object in the second camera's FOV in terms of one or more tiles of the set of tiles in the second camera's FOV 103. The method continues by detecting the second object in the first region of the first camera's FOV, wherein the second region of the second camera's FOV at least partially overlaps with the first region of the first camera's FOV 104; and by determining a location of the second object in the first camera's FOV in terms of one or more tiles of the set of tiles in the first camera's FOV 105. Method includes spatially calibrating the second region in the second camera's FOV to the first region in the first camera's FOV by mapping the one or more tiles determined as the location of the second object in the second camera's FOV to the one or more tiles determined as the location of the second object in the first camera's FOV 106; and storing the mapping information to a storage location of the VMDB 107. A population phase may be implemented at first, before use of the VMDB, in order to fill-in data to the VMDB. The VMDB is populated with data on camera view locations corresponding to each other among cameras of a multi-camera system.

A camera captures image data, like image frames or video sequences. An object of interest may be detected from the image data. Detecting the object of interest may be a trigger for a streaming function for a multi-camera system. Camera coverages are divided into tiles, and tiles of a camera may be superimposed on the corresponding camera coverage view. If the object is found to move towards an edge of the camera FOV, the device including or hosting the camera is configured to retrieve information on other cameras of the multi-camera system that cover the same object. Regions comprising the tiles, which include the detected object in question, may be used instead of the whole image. Information on regions of common objects among FOVs of different cameras is retrieved form a VMDB. This enables to recognize the camera that is best suited to continue the streaming. The stream is handed over to the next device. For example, push origin or representational state transfer, REST, based systems may be utilized for handover. A device that is handing over the streaming may crop the image of the detected object. The handover request may include a cropped image of the detected object. The cropped image may enhance identification of the object, which may be implemented using a function or a service for re-identification, ReID. Retrieved VMDB data enables to run ReID for a retrieved set of one or more tiles, instead of the whole image data of the cameras, whose FOV includes the common object.

A ReID may be used to find the first appearance of an object. In this case, a stream is started in response to a request including an input image of the object. The devices of the multi-camera system may be configured to periodically run ReID on the captured image data from their cameras in order to detect and identify objects. The devices are configured to compute similarity between objects detected in the captured images and the input image of the object. When similarity is detected, the object of the input image is considered to be found from the image data, and streaming is started. During streaming only object detection is run, instead of ReID, which is more expensive and/or less effective. Tracking the object is implemented using tiles of camera coverage or FOV for locating the object. For historical, past stream requests, the request shall include a timestamp, which may be used as a starting point to run an ReID on the images recorded in the devices. Once the object is found, the process may continue by object detection.

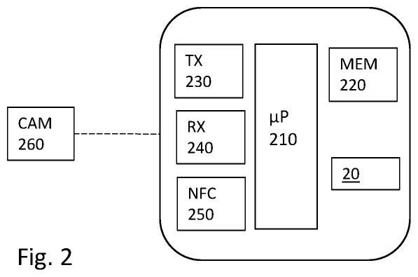

FIG. 2 shows, by way of example, an apparatus capable of processing image data, for example object detection and re-identification. Illustrated is device 20, which may comprise, for example, a mobile communication device, a cellular phone, a server computer, an edge hardware, an image capture device, a video capture device, such as a camera. Comprised in device 20 is processor 210, which may comprise, for example, a single- or multi-core processor wherein a single-core processor comprises one processing core and a multi-core processor comprises more than one processing core. Processor 210 may comprise, in general, a control device. Processor 210 may comprise more than one processor. Processor 210 may be a control device. A processing core may comprise, for example, a Cortex-A8 processing core manufactured by ARM Holdings or a Steamroller processing core designed by Advanced Micro Devices Corporation. Processor 210 may comprise at least one Qualcomm Snapdragon and/or Intel Atom processor. Processor 210 may comprise at least one application-specific integrated circuit, ASIC. Processor 210 may comprise at least one field-programmable gate array, FPGA. Processor 210 may be means for performing method steps in device 20. Processor 210 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a camera, an edge device or a server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 20 comprises memory 220. Memory 220 may comprise random-access memory and/or permanent memory. Memory 220 may comprise at least one RAM chip. Memory 220 may comprise solid-state, magnetic, optical and/or holographic memory, for example. Memory 220 may be at least in part accessible to processor 210. Memory 220 may be at least in part comprised in processor 210. Memory 220 may be means for storing information. Memory 220 may comprise computer instructions that processor 210 is configured to execute. When computer instructions configured to cause processor 210 to perform certain actions are stored in memory 220, and device 20 overall is configured to run under the direction of processor 210 using computer instructions from memory 220, processor 210 and/or its at least one processing core may be considered to be configured to perform said certain actions. Memory 220 may be at least in part external to device 20 but accessible to device 20.

Device 20 may comprise a transmitter 230. Device 20 may comprise a receiver 240. Transmitter 230 and receiver 240 may be configured to transmit and receive, respectively, information in accordance with at least one cellular or non-cellular standard. Transmitter 230 may comprise more than one transmitter unit. Receiver 340 may comprise more than one receiver unit. Transmitter 230 and/or receiver 240 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 20 may comprise a near-field communication, NFC, transceiver 250. NFC transceiver 250 may support at least one NFC technology, such as NFC, Bluetooth, Wibree or similar technologies. Device 20 may comprise a connection port, like an Ethernet port, enabling wired connection including a cable connection, a router and/or a modulator-demodulator. Device 20 may comprise a network interface, like an input-output, IO, port.

Device 20 may comprise user interface, UI. UI may comprise at least one of a display, a keyboard, a touchscreen, a vibrator configured to signal to a user by causing device 20 to vibrate, a speaker and a microphone. A user may be able to operate device 20 via UI, for example to manage digital files stored in memory 220 or on a cloud accessible via transmitter 230 and receiver 240, or via NFC transceiver 250, and/or to play games.

Processor 210 may be furnished with a transmitter configured to output information from processor 210, via electrical leads internal to device 20, to other devices comprised in device 20. Such a transmitter may comprise a serial bus transmitter configured to, for example, output information via at least one electrical lead to memory 220 for storage therein. Alternatively to a serial bus, the transmitter may comprise a parallel bus transmitter. Likewise processor 210 may comprise a receiver configured to receive information in processor 210, via electrical leads internal to device 20, from other devices comprised in device 20. Such a receiver may comprise a serial bus receiver configured to, for example, receive information via at least one electrical lead from receiver 240 for processing in processor 210. Alternatively to a serial bus, the receiver may comprise a parallel bus receiver.

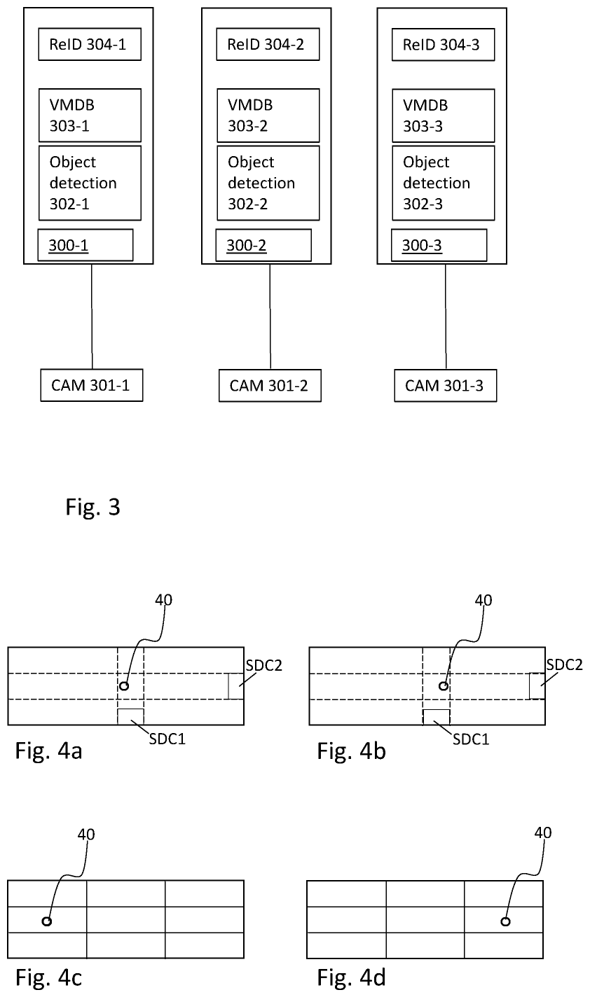

Device 20 may comprise further devices not illustrated in FIG. 3. For example, where device 20 may comprise at least one camera. Device 20 may be configured to receive image data from at least one camera. A camera may be a nearly exclusive uplink only device configured to load images or video clips to a network. A camera may comprise features, functions and/or modules of one or more of: a bullet camera, a dome camera, a covert camera, a discreet camera, an infrared camera, a night vision camera, a power on Ethernet (POE) camera, an outdoor camera, a day/night camera, a varifocal camera, a video camera, a network camera, an internet protocol (IP) camera, a wireless camera, a pan-tilt-zoom (PTZ) camera, a high-definition camera, a closed circuit television (CCTV) camera, and/or a software defined camera. In some example embodiments, device 20 lacks at least one device described above. For example, some devices 20 may lack a NFC transceiver 250 and/or user identity module.

Processor 210, memory 220, transmitter 230, receiver 240, NFC transceiver 350, and/or a camera may be interconnected by electrical leads internal to device 20 in a multitude of different ways. For example, each of the aforementioned devices may be separately connected to a master bus internal to device 20, to allow for the devices to exchange information. However, as the skilled person will appreciate, this is only one example and depending on the embodiment various ways of interconnecting at least two of the aforementioned devices may be selected.

A network architecture of a communication system may comprise a radio access architecture based on long term evolution advanced (LTE Advanced, LTE-A) or new radio (NR), also known as fifth generation (5G), without restricting the embodiments to such an architecture. Other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. A communication system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. Network nodes or their functionalities may be implemented by using any node, host, server or access point, or an entity suitable for such usage. 5G mobile communications supports a wide range of use cases and related applications including video streaming, virtual reality, extended reality, augmented reality, different ways of data sharing and various forms of machine type applications, including vehicular safety, different sensors and real-time control. 5G is expected to have multiple radio interfaces, and also being integratable with existing legacy radio access technologies, such as the LTE. The communication system is also able to communicate with other networks, such as a public switched telephone network (PSTN) or the Internet, or utilize services provided by them, for example via a server. The communication network may also be able to support the usage of cloud services. Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit) and non-real time functions being carried out in a centralized manner (in a centralized unit).

FIG. 3 illustrates, by way of an example, a block diagram of a system. The system is a multi-camera system comprising multiple cameras 301-1, 301-2, 301-3. The cameras throughout this application may be software defined cameras, whose software, like algorithms and data processing, may be decoupled from camera hardware. The cameras 301-1, 301-2, 301-3 are configured to capture image data on their image sensors. The cameras 301-1, 301-2, 301-3 provide image data, for example digital image data, image frames or frames of video sequence. The system comprises an object detection module 302-1, 302-2, 302-3 for each camera 301-1, 301-2, 301-3. The object detection module 302-1, 302-2, 302-3 is configured to detect an object from image data. Object detection may detect instances of semantic objects of a certain predefined classes or object types, for example humans, buildings, cars, and so on. The object detection module 302-1, 302-2, 302-3 may comprise, for example, face detection, feature recognition and/or colour identification. An object detection module 302-1, 302-2, 302-3 may be configured to identify a predefined object type on image data produced by cameras 301-1, 301-2, 301-3. The system comprises a re-identification, ReID, module 304-1, 304-2, 304-3 for each camera 301-1, 301-2, 301-3. The re-identification module 304-1, 304-2, 304-3 is configured to extract features of the detected objects, which are detected by the object detection module 302-1, 302-2, 302-3. The re-identification module 304-1, 304-2, 304-3 is configured to identify unique objects. The re-identification module 304-1, 304-2, 304-3 may compute, calculate, compare and/or match similarity of the detected objects in order to identify unique objects. A ReID module may comprise a ReID algorithm. The ReID algorithm may utilize features, like visual and/or geographical features, in order to associate common objects among, or between cameras. The ReID algorithm may assign an identifier, ID, for every detected object. The ID is used for all cameras for the same object. Detection of the same object is assigned to the same ID by the cameras of the multi-camera system. The system comprises view mapping databases, VMDB, 303-1, 303-2, 303-3 for each camera 301-1, 301-2, 301-3. A VMDB 303-1, 303-2, 303-3 is configured to store mapping information between the cameras 301-1, 301-2, 301-3, including information on regions of a camera FOV and regions of camera FOVs of the other cameras of the system mapped to it. Full coverage of each camera 301-1, 301-2, 301-3 is divided into a set of tiles. Tiles correspond to rectangular spatial areas, which cumulatively cover entire coverage of a camera of at least some or all cameras of the system. A location of a detected object is determined by a region comprising one or more tiles. The VMDB is configured to comprise information on detected objects and their locations, which are determined in terms of one or more tiles. The VMDB comprises the information regarding regions of the cameras of the camera system, whose FOVs include the same object. When the same object is detected in two or more camera's FOV, the regions of the same object between the two or more cameras are found to match. A mapping information is formed based on the matching regions of two or more camera's FOVs and stored to the VMDB. In addition or instead of detected objects, identified objects, for example identified using ReID, may be used. The VMDB is configured to populate the VMDB instances based on detected and/or identified common objects and locations of those.

In FIG. 3 the object detection 302-1 module is configured to produce an object type and object location (region) for objects detected from captured data of the camera 301-1. The other object detection modules 302-2, 302-3 produce the same for captured data of the cameras 301-2, 301-3, correspondingly. An object type and a corresponding region (in terms of tiles) may be provided for each detected object and for each camera of the system detecting the object. Regions comprising a detected object are mapped to regions of the other camera's comprising the same object. ReID modules 304-1, 304-2, 304-3 are configured to compare and match features. Information is stored in VMDB instance 303-1, 303-2, 303-3 of the corresponding device 300-1, 300-2, 300-3. VMDB instances 303-1, 303-2, 303-3 include information on overlapping areas of the cameras 301-1, 301-2, 301-3, based on the common objects and their locations in FOVs of the camera's 301-1, 301-2, 301-3. VMDB 303-1, 303-2, 303-3 instances comprise information on overlapping regions of the cameras 301-1, 301-2, 301-3 of the system. Use of object detection and location of the objects by mapping information and overlapping regions enables tracking objects and/or events by processing collection of regions. This avoids need to identify objects in all the cameras, which is less effective due to feature extraction.

Information of VMDB instances 303-1, 303-2, 303-3 may be requested between the devices 300-1, 300-2, 300-3 of the system. ReID modules 304-1, 304-2, 304-3 are configured to handle requests including regions in form of tiles of the requesting camera FOV. ReID modules 304-1, 304-2, 304-3 are configured to extract features, compare features in order to identify objects and assign an identifier for an object. An identifier may enable to match the objects between camera FOVs. A cropped image and region information (tiles) of a requesting camera may be sent to a local camera VMDB, which sends the request to a local camera ReID. If received tiles of the requesting camera and tiles of the local camera are found to match, the mapping is stored to a data store or a storage location of the VMDB. Presence of a match and tiles matching with the request are provided by ReID. The mapping information is shared to the requesting camera device, or VMDB of it.

In FIG. 3 VMDB instances are deployed for each camera. A local VMDB instance (303-1, 303-2, 303-3 of FIG. 3) includes a local coverage/FOV of the corresponding camera. Each camera 301-1, 301-2, 301-3 of FIG. 3 is served by a device 300-1, 300-2, 300-3. Each device 300-1, 300-2, 300-3 of FIG. 3 is configured to host modules providing services for object detection 302-1, 302-2, 302-3, re-identification 304-1, 304-2, 304-3, and VMDB 303-1, 303-2, 303-3. The modules may be implemented in containers, virtual machines or processes, for example. The modules, which may be called functions and/or services, may comprise executable instructions. The device 300-1, 300-2, 300-3 may be an edge device. Modules or functions of object detection, ReID and VMDB may be hosted and located centrally. VMDB may be configured in a central location to serve multiple cameras. A central VMDB may include a global coverage/FOV of multiple cameras. For example, one or more instances of the modules or functions may be configured to serve all or a subset of the cameras of the system. Location and number of the instances with respect to the number of cameras may vary.

Embodiments may use detected objects, as described. In addition, or instead of detected objects, identified objects may be used. The objects may be identified using ReID function. ReID function may be run on the selected regions only. Tracking may be implemented using the regions and object detection function.

An edge device, like 300-1, 300-2 or 300-3 of FIG. 3, may comprise a hardware and/or a software edge accelerator. An edge device enables a cloud scale machine learning inferences to run locally, near the sensory data sources, like cameras and microphones. This improves efficiency, latency and throughput by reducing or avoiding need to send large volume of data to remote data centres. While cloud environments may be used for computing heavy machine learning model training, edge devices may provide inference capabilities. A machine learning task may involve first preparing captured data to a compatible input format. Captured data may comprise pixels from an image sensor and/or waveforms from a microphone. Secondly, the machine learning task may comprise executing a machine learning model, optionally utilizing artificial intelligence and neural networks. Thirdly, the machine learning task may comprise interpreting output of the machine learning model in order to create inferences. Fourthly, the machine learning task may comprise serving the inferences through well-defined interfaces, like representational state transfer application programming interfaces, REST APIs. Inferences may be stored in order to enable use of historical queries. Sensors, like cameras, are being pervasively deployed for different areas and functions, like traffic monitoring, industrial applications, virtual reality applications, augmented reality applications, surveillance. Cameras are used for investigation purposes, for example, after occurrence of an event of interest. Deploying edge computing for collaborative sensing mechanism enables lowering bandwidth, reducing response time and improving efficiency.

VMDB is configured to provide overlapping regions among multiple cameras. In other words, between or in group of multiple cameras. VMDB enables implementation of a collaborative visual analytics system for edge environments. This enables reducing number of times that feature extraction models are applied on image data captured by cameras. Instead, more effective object detection and bounding box tracking mechanisms are utilized. VMDB provides mechanism for spatial, temporal and pan-tilt-zoom, PTZ, calibration. VMDB enables to address inaccuracies due to object depth, lack of synchronization and camera movements.

Object detection, re-identification, ReID, and view mapping database, VMDB, may be implemented as executable instructions. The corresponding modules of executable instructions may be stored in a memory and executed by a processor. The devices and modules of FIG. 3 may operate as standalone device or be connected, for example, via network, to other computer system, service system, server system, storage system or peripheral device. Devices and/or modules of the devices of FIG. 3 may communicate with each other through various mechanisms, for example using remote procedure calls, inter-process communication tools, or representational state transfer, REST, application programming interfaces, also known as RESTful APIs.

Information on common objects and their locations among multiple cameras is stored in one or more VMDB. A camera, or a device comprising or hosting a camera, may receive a query on a common object location in the camera's FOV. The query may be sent by a remote camera of a multi-camera system. The query includes an identified object type and the remote camera FOV region of the object type. The query information is compared to the FOV of the query receiving camera in order to detect the identified object type and its location. The comparison is done in an ReID module. The response includes the FOV region(s), which correspond to the identified object type location at the query receiving camera. In addition, the response may include overlapping regions of one or more other remote cameras. A response may have, for example, the following format:

{[{“camera_id”: <local camera id>,
“object class”: <object type>,
“object_location”: <object bounding box>
“object region”: <region in the local camera's field>,
“overlapping_regions: [
{“sdc_id”: <remote camera id>,
“region”: <region in the remote camera>},
{“sdc_id”: <remote camera id>,
“region”: <region in the remote camera>}]},
{“object_class”: <object type>,
“object_location”: <object bounding box>,
“object_region”: <region in the local camera's field>,
“overlapping_regions”:[
{“sdc_id”: <remote camera id>,
“region”: <region in the remote camera>}]}]}

The response or the fields of it may be implemented in different format and/or comprise additional fields and/or field names.

In an embodiment, a multi-camera system is monitoring traffic. In order to query a total number of objects, e.g. cars in the full FOV covered by the cameras, a separate query may be made to each device of the system including or hosting a camera. As a response to the query, a list of detected cars, bounding boxes of the cars, corresponding regions in the camera's FOV/coverage and regions in other camera FOVs/coverages are retrieved. This enables identifying the identical objects, without performing any additional or extra processing on the image data, and further, deducing the total number of cars by simply using regions of the cars and locations of the cars in the camera coverage. One of the devices of the system may be configured to eliminate redundancy by reducing the cars that are detected by multiple cameras. This enables to return the result without any additional processing.

FIGS. 4a-b illustrate, by way of example, an aerial view of two cameras. The aerial view is covered by cameras SDC1 and SDC2. An object 40, which is illustrated by a circle, is captured by both cameras at the same time instance. In FIG. 4a illustrated camera view is covered by the cameras SDC1 and SDC2 at the time instance t1. Camera view regions, or FOVs of cameras SDC1 and SDC2 both contain the object 40. The FOVs of the cameras SDC1 and SDC2 map to each other. In FIG. 4b the aerial view is covered by the cameras SDC1 and SDC2 at a time instance t2, which is later than t1 of FIG. 4a. FIGS. 4a-b show two aerial views, by two cameras SDC1, SDC2, at two sequential time instances t1, t2. FIGS. 4c-d illustrate, by way of example, an aerial view of a camera. FIG. 4c illustrate a view of SDC1 at the time instance of t1. FIG. 4d illustrates a view of SDC2 at the time instance of t1. FIGS. 4a-d enable implementing spatial calibration.

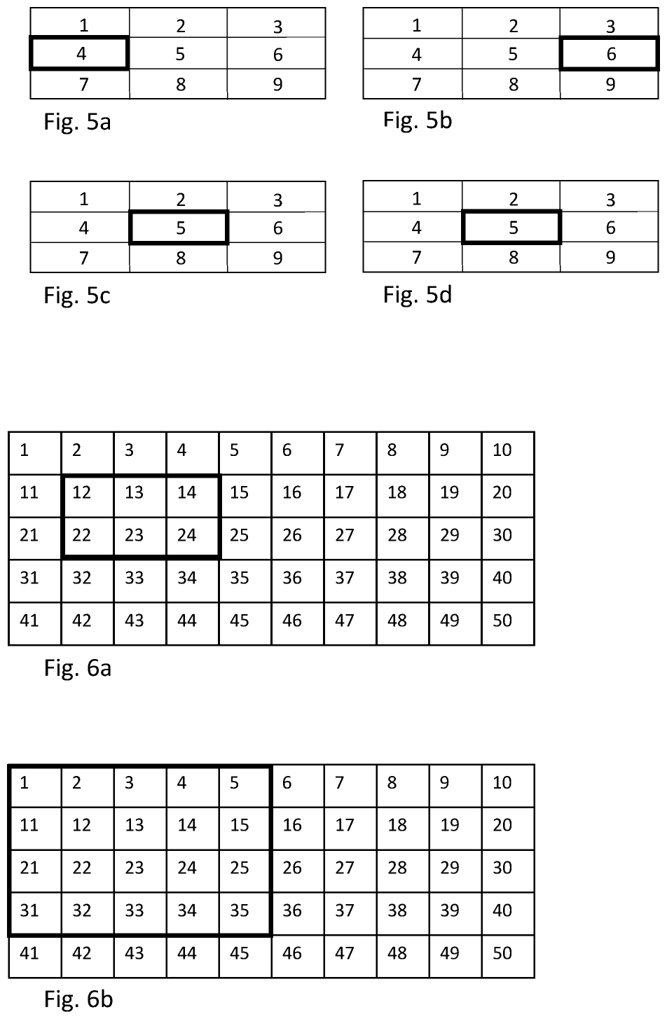

FIGS. 5a-d illustrate, by way of examples, a region of a camera view. FIG. 5a illustrates a region of SDC1 FOV at the time instance t1. The object is located in the tile 4 of the region of the SDC1 FOV. FIG. 5b illustrates a region of SDC1 FOV at the time instance t2. The object is located at tile 6 of the region of the SDC1 FOV. FIG. 5c illustrates a region of SDC2 FOV at the time instance t1. FIG. 5d illustrates a region of SDC2 FOV at the time instance t2. The object is located in the tile 5 of the SDC2 FOV in both instances of time, t1 and t2, as shown in FIGS. 5cd. The cameras SDC1 and SDC2 view object from different angles. When mapping the tile 5 of the SDC2 FOV to the SDC1 FOV, it would be straightforward to map the tile 5 of the SDC2 FOV to the tiles 4 and 6 of SDC1 FOV. However, this may be inaccurate and insufficient. Instead, the object detected in the tile 5 of SDC2 FOV is mapped to regions {4}, {5}, {6}, {4, 5}, {5, 6} and {4, 5, 6} of SDC1 FOV. Mapping regions may be dependent on the size of the object. Regions of commonly detected objects are updated to a VMDB during a population phase by multiple cameras. In addition to overlapping regions (based on the same object), spatial calibration may enlarge a region to be mapped. Region of any one of cameras may be enlarged. A continuous region is formed using spatial calibration. A spatially calibrated region comprises a list of regions that are contiguous subsets of the tiles that take place between the tiles indicated as the detected locations. All subsets of identified tiles are not simply included. Rather, a continuous region may be formed by adding neighbouring tiles. For example, in FIGS. 5a-d the subset {4, 6} is not included, as it is not contiguous region. The two tiles, {4}, {6}, indicated as the detected locations are not next to each other, so the two would not form a contiguous region of adjacent tiles, but two separate regions.

FIGS. 6a-b illustrate, by way of examples, mapping a remote camera region to a local camera region. A local camera may identify an object and location of the object in the local camera FOV. A local region of the local camera FOV is used for mapping corresponding regions of other cameras of a multi-camera system. FIG. 6a illustrates a region (tiles 12, 13, 14, 22, 23, 24) in a remote camera FOV that is configured to map to a query including a local region of a local camera FOV. A query on mapping regions may be sent by a device including or hosting a local camera. A query on mapping regions may be responded by a device including or hosting a remote camera. A query is responded by identifying a region. A mapping region may be determined based on the detected or identified object and/or overlapping regions of the cameras. Instead of using the mapping region of FIG. 6a, the region as illustrated in FIG. 6b is reported. Region of FIG. 6b comprises the mapping region of FIG. 6a and the tiles around it. One or more additional tiles contiguous with the mapping region is added to the tiles of the mapping region. Providing a larger region than initial mapping region may lead to increased number of ReID operations to identify objects in the reported region. However, this enables providing accuracy to the response.

FIGS. 6a-b enable implementation of temporal calibration. Cameras of a multi-camera system may not be in synchronization. Complete synchronization cannot be guaranteed even if cameras use a synchronization utility. When sending cropped images to the ReID, a VMDB may include a time stamp of the cropped image, which includes a number of tiles. During population phase, upon receiving a request from a VMDB (303-1 of FIG. 3), ReID (304-2 of FIG. 3) may use the image of camera (301-2 of FIG. 3) that is created, i.e. including a timestamp, at a time closest to the timestamp of the received cropped image. The two timestamps and/or time instances may differ. Inaccuracies may arise due to time differences, for example an object may move beyond the region indicated by a VMDB. The VMDB providing a larger region than direct mapping provides, as illustrated in FIGS. 6a-b, enables to address this issue.

VMDB has divided the full coverage of a camera into rectangular tiles. Field of view, FOV, of the camera is a subset of its coverage. A particular set of one or more tiles consistently refer to a specific region covered by the camera. VMDB is populated by providing identified object and its location. The location is determined as a region and expressed as a set of one or more tiles. The VMDB, which may be deployed centrally and/or by local instances, stores information about regions that overlap among cameras of a multi-camera system. The VMDB and information stored in such enables concentrating on image parts, determined by the tiles, which have been found relevant. Relevance may be based on a detected object, object ID, an event, or camera configurations. Matching between regions among cameras of the multi-camera system may be created using ReID. Changes on captured images and/or camera settings have effect on updates and number of queries, which in turn require efficiency for adapting and providing responses, preferably in real time. Use of VMDB enables use of object detection replacing multiple runs of ReID. Further, relevant locations, i.e. tiles of camera FOV, are identified and those are processed instead of the whole image data.

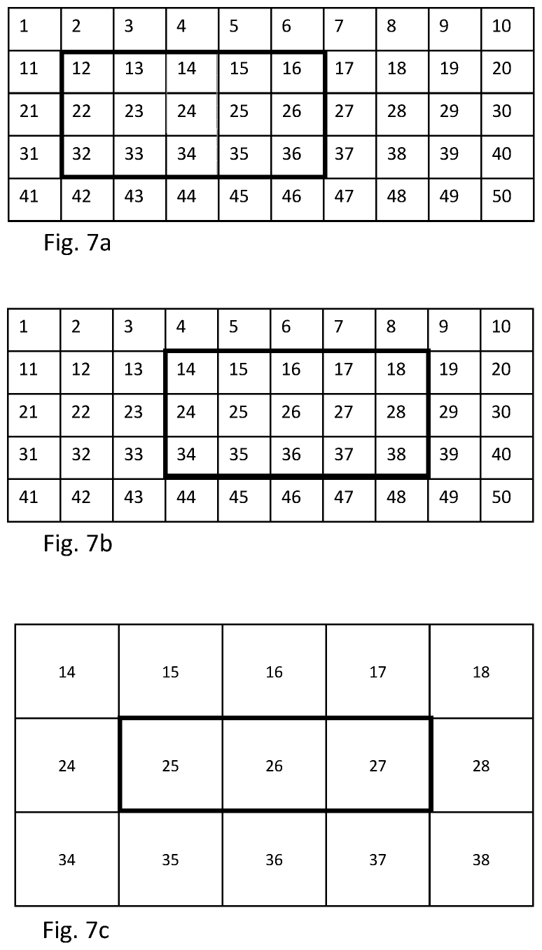

FIG. 7a-c show, by way of example, mapping a local camera view. A view, or a field of view, FOV, of a camera comprises a subset of the camera coverage. A FOV available at a time instance may comprise a set of one or more tiles. As the FOV changes due to change of camera direction or zoom, the available FOV, as well as available set of one or more tiles, changes correspondingly. FIG. 7a shows coverage of a camera, which is divided into tiles numbered from 1 to 50. Current FOV of the camera at time instance t1 is shown as a rectangle between tiles 12-36. FIG. 7b shows the FOV after the camera has moved towards right, at a time instance t2. The FOV at the time t2 is shown as a rectangle between tiles 14 and 38. Every tile is configured to identify the same region in the camera's coverage, even if the camera is moved or camera settings are changed. FIG. 7c shows the FOV after the camera is zoomed in, at a time instance t3. The size of tiles is enlarged corresponding to the zoom, and smaller number of tiles, 25-27, represent the FOV at the time t3. A VMDB is configured to receive camera configurations or settings, like zoom level and direction of the camera, from the camera. The VMDB is configured to detect corresponding tiles based on the camera configuration and/or settings. A camera may be configured to save camera settings and configuration, for example in a local memory. This enables VMDB to access the saved information, for example, in order to handle historical queries. FIGS. 6a-c enable implementation of PTZ calibration. PTZ calibration provides accuracy in a local PTZ camera, while spatial and temporal calibration relate mapping regions of one or more cameras, which may be remote.

Video analytics at an edge enable utilizing computation power of the edge or cloud in order to run real time video analytics consisting multiple machine learning operations. The embodiments provide efficiency and enable avoiding linearly growing resource consumption, which is due to per stream optimization as the number of video feeds increase. It has been possible to incorporate learning spatial and temporal relationship between the video feeds, e.g. obtained from geo-distributed locations when camera FOVs do not overlap. Where FOVs overlap and multiple cameras are viewing the same area concurrently, analysing all the frames poses demands to resources. A collaborative cross camera video analytics system may decide the next camera based on usefulness of investigated frame. Reducing network load, but maintaining timely and accurate video analysis, may be achieved using region of interest masks of the FOV during runtime. Masks enable cropping images so that, instead of the whole image data, only subset of the image data is sent to a cloud server for processing. Still the cloud server shall identify common identical objects from multiple cameras. Such is avoided by the previously presented, where overlapping regions and identical objects are taken into account. Additional image processing is avoided, and instead spatial-temporal queries may be handled by processing information on a location of a common object or event among camera views.

The illustrated examples and embodiments are not necessarily indicative of the order of processing or performing steps or phases. For example, some phases may be performed in a different order and/or in parallel.

It is to be understood that the embodiments of the invention disclosed are not limited to the particular structures, process steps, parts or blocks disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided in order to provide a thorough understanding of aspects of the invention. One skilled in the relevant art will recognize, however, that the invention can be practiced without one or more of the specific details, or with other methods, components, phases, etc. In other instances, well-known structures or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The open limitations include the closed limitations as defined. The features recited in depending claims are mutually freely combinable unless otherwise explicitly stated. Furthermore, it is to be understood that the use of “a” or “an”, that is, a singular form, throughout this document does not exclude a plurality.

1. An apparatus for a multi-camera system comprising at least a first camera and a second camera, wherein coverage of the first camera and coverage of the second camera is divided into a set of tiles, the apparatus comprising:
a module configured to detect an object in first region on the first camera's field of view, FOV, a module configured to determine a location of the object in terms of one or more tiles of the set of tiles in the first camera's view, a module configured to request a mapping information identifying one or more tiles of the set of tiles in the second camera's FOV that corresponds to the one or more tiles of the set of tiles in the first camera's FOV;
a module configured to receive a response from a view mapping database that is configured to identify the one or more tiles of the set of the tiles in the second camera's FOV that correspond to the one or more tiles of the set of tiles in the first camera's FOV, where the response further identifies one or more additional tiles contiguous with the identified one or more tiles of the set of tiles in the second camera's FOV;
a module configured to share the response from the first camera to the second camera such that the second camera is enabled to find the object in the one or more of the tiles identified in the response.

2. An apparatus according to the claim 1, further configured to populate the view mapping database comprising:
a module configured to divide coverage of each camera of the multi-camera system into a set of tiles;
a module configured to detect a second object in a second region on a second camera's FOV;
a module configured to determine a location of the second object in the second camera's FOV in terms of one or more tiles of the set of tiles in the second camera's FOV;
a module configured to detect the second object in the first region of the first camera's FOV, the second region of the second camera's FOV at least partially overlapping with the first region of the first camera's FOV;
a module configured to determine a location of the second object in the first camera's FOV in terms of one or more tiles of the set of tiles in the first camera's FOV;
a module configured to spatially calibrate the second region in the second camera's FOV to the first region in the first camera's FOV by mapping the one or more tiles determined as the location of the second object in the second camera's FOV to the one or more tiles determined as the location of the second object in the first camera's FOV;
a storage location of the view mapping database configured to store the mapping information.

3. The apparatus according to the claim 2, wherein the module configured to spatially calibrate is further configured to perform at least one of: enlarging the second region, forming a continuous region, and forming a list of regions that are contiguous subset of the tiles that take place between the at least two tiles determined as the location.

4. The apparatus according to claim 1, wherein the tiles comprise rectangular spatial regions, which cumulatively cover a full coverage of at least some or all cameras such that a tile placement is constant and fixed in relation to the full coverage of each camera of the at least some or all cameras.

5. The apparatus according to claim 1, wherein at least some or all cameras of the multi-camera system comprise at least one of: a software defined camera and a pan-tilt-zoom camera.

6. The apparatus according to claim 1, comprising
a module configured to change FOV of a camera of the multi-camera system in response to changed camera configurations, which include at least one of pan, tilt, direction and zoom, and configured to maintaining the placement of the set of tiles in relation to the full coverage of the camera of the multi-camera system.

7. The apparatus according to claim 1, comprising a re-identification module configured to extract a cropped image, which comprises a region of the detected object, and optionally a time stamp of the cropped image.

8. The apparatus according to claim 1, wherein the mapping information comprises at least one of:
regions, wherein at least one or all of the regions comprise one or more tiles indicated as detected location, and one or more tiles next to the detected location, and
a contiguous region based on the location of the object in the at least partially overlapping regions of the camera FOVs.

9. The apparatus according to claim 1, comprising an object detection module and a re-identification module.

10. The apparatus according to claim 1, comprising a system configured to serve one or more camera of the multi-camera system, wherein the system comprises the view mapping database, an object detection module and a re-identification module.

11. The apparatus according to the claim 10, wherein the system comprises an edge system.

12. The apparatus according to claim 10, wherein the system is one of: a local system for a camera or a global system for multiple cameras.

13. The apparatus according to claim 1, comprising at least one processor; and at least one memory including computer program code, the at least one memory and the computer program code configured to, with the at least one processor, cause the performance of the apparatus.

14. A method for a multi-camera system, wherein the multi-camera system comprises at least a first camera and a second camera, wherein coverage of the first camera and coverage of the second camera is divided into a set of tiles, the method comprising:
detecting an object in a first region on the first camera's field of view, FOV;
determining a location of the object in terms of one or more tiles of the set of tiles in the first camera's FOV;
requesting a mapping information identifying one or more tiles of the set of tiles in the second camera's FOV that corresponds to the one or more tiles of the set of tiles in the first camera's FOV;
receiving a response from a view mapping database that is configured to identify the one or more tiles of the set of the tiles in the second camera's FOV that correspond to the one or more tiles of the set of tiles in the first camera's FOV, where the response further identifies one or more additional tiles contiguous with the identified one or more tiles of the set of tiles in the second camera's FOV;
sharing the response from the first camera to the second camera such that the second camera is enabled to find the object in the one or more of the tiles identified in the response.

15. A method according to the claim 14, further comprising a population phase of the view mapping database comprising:
dividing coverage of each camera of the multi-camera system into a set of tiles;
detecting a second object in a second region on a second camera's FOV;
determining a location of the second object in the second camera's FOV in terms of one or more tiles of the set of tiles in the second camera's FOV;
detecting the second object in the first region of the first camera's FOV, the second region of the second camera's FOV at least partially overlapping with the first region of the first camera's FOV;
determining a location of the second object in the first camera's FOV in terms of one or more tiles of the set of tiles in the first camera's FOV;
spatially calibrating the second region in the second camera's FOV to the first region in the first camera's FOV by mapping the one or more tiles determined as the location of the second object in the second camera's FOV to the one or more tiles determined as the location of the second object in the first camera's FOV;
storing the mapping information to a storage location of the view mapping database.

16. The method according to the claim 15, wherein spatially calibrating comprises at least one of: enlarging the second region, forming a continuous region, and forming a list of regions that are contiguous subset of the tiles that take place between the at least two tiles determined as the location.

17. The method according to claim 14, wherein the tiles comprise rectangular spatial regions, which cumulatively cover a full coverage of at least some or all cameras such that a tile placement is constant and fixed in relation to the full coverage of each camera of the at least some or all cameras.

18. The method according to claim 14, wherein at least some or all cameras of the multi-camera system comprise a software defined camera and/or a pan-tilt-zoom camera.

19. The method according to claim 14, comprising
changing FOV of a camera of the multi-camera system in response to changed camera configurations, which include at least one of pan, tilt, direction and zoom, while maintaining the placement of the set of tiles in relation to the full coverage of the camera of the multi-camera system.

20. The method according to claim 14, comprising running a re-identification for a cropped image, which comprises a region of the detected object, and optionally a time stamp of the cropped image.

21-27. (canceled)
